(19) United States
(12) Patent Application Publication
(10) Pub. No.: US 2025/0186939 A1
(43) Pub. Date: Jun. 12, 2025

(54) EFFICIENT LIQUID-AIR CONTACTOR IN PARALLEL FLOW CONFIGURATION

(71) Applicant: The Johns Hopkins University, Baltimore, MD (US)

(72) Inventors: Chao WANG, Ellicott City, MD (US); Yulin Liu, Baltimore, MD (US)

(21) Appl. No.: 19/038,848

(22) Filed: Jan. 28, 2025

Related U.S. Application Data
(63) Continuation of application No. PCT/US2023/071488, filed on Aug. 2, 2023.
(60) Provisional application No. 63/370,260, filed on Aug. 3, 2022.

(51) Int. Cl. B01D 53/18; B01D 53/14; B01D 53/22; B01D 63/04; B01D 69/02; B01D 71/26

(52) U.S. Cl. CPC B01D 53/18; B01D 53/1475; B01D 53/228; B01D 53/229; B01D 63/04; B01D 69/02; B01D 71/262; B01D 2053/224; B01D 2251/304; B01D 2251/306; B01D 2251/604; B01D 2257/504; B01D 2258/06; B01D 2325/38

(57) ABSTRACT

The present invention is in the field of carbon dioxide capture, in particular the capture of carbon dioxide directly from air or some other emission source. The invention concerns a device and a process for the capture of carbon dioxide, from air or some other emission source, using hydroxide solutions as the sorbent.

### CROSS-REFERENCE TO RELATED APPLICATIONS

This application claims the benefit of U.S. Provisional Application No. 63/370,260, filed Aug. 3, 2022, the contents of which are incorporated herein by reference in its entirety.

### FIELD

The present invention is in the field of carbon dioxide capture, in particular the capture of carbon dioxide directly from air or some other emission sources. The invention concerns a device comprising a membrane air contactor and a process for the capture of carbon dioxide from air or some other emission sources using same.

### BACKGROUND

Recently, the necessity to reduce the carbon dioxide footprint of mankind has led to the development of many processes wherein CO₂, the major greenhouse gas accounting for global warming, is used as feedstock. Ironically, these emerging technologies are hampered by the limited availability of CO₂. Processes to capture CO₂ from gases rich in CO₂, such as industrial flue gases, have been developed, but cannot account for the demand for CO₂. Furthermore, such processes may lower the emission of CO₂ into the environment, but the concentration of CO₂ already present in the environment is not affected. Hence, there is a need for capturing CO₂ directly from air, which would lower the CO₂ concentration in the environment.

Devices and processes for capturing CO₂ from air are known in the art. For example, devices containing a porous sorbent material wherein the sorbent adsorbs or binds the CO₂, as well as systems that dissolve CO₂ in an aqueous solution for capture and subsequent release, are known. Disadvantageously, the systems and processes of the prior art tend to be very energy intensive.

There is a continuing need for an efficient and economically viable device for capturing a gas such as CO₂ directly from air or other emission sources, which avoids the large pressure differences of a fluidized bed reactor as well as the energy consuming regeneration of loaded sorbent dissolved in water. Described herein is a liquid-gas membrane air contactor that efficiently captures gas such as CO₂ from the air and other emission sources in a liquid source.

### SUMMARY

In some aspects, an air contactor membrane module comprising one of options (A), (B), (C), (D) or (E) is described:
(A) a tubular housing for flowing liquid therethrough; and
a plurality of hollow fibers positioned within the tubular housing, wherein each hollow fiber comprises a membrane enclosing an interior for flowing gas therethrough, wherein the plurality of hollow fibers comprise pores for passage of a gaseous species from the interior through the membrane to the liquid, and wherein at least one side of the membrane of each hollow fiber is substantially hydrophobic; or
(B) a tubular housing for flowing gas therethrough; and
a plurality of hollow fibers positioned within the tubular housing, wherein each hollow fiber comprises a membrane enclosing an interior for flowing liquid therethrough, wherein the plurality of hollow fibers comprise pores for passage of a gaseous species through the membrane into the liquid in the interior, and wherein at least one side of the membrane of each hollow fiber is substantially hydrophobic; or
(C) a housing comprising stacked gas-liquid sections therein, wherein a gas and a liquid are partitioned or separated by a membrane, wherein stacked gas-liquid sections are arranged as (L-M-G-M-)ₙ-L, or (G-M-L-M-)ₙ-G, wherein G is a gas section, M is a membrane, L is a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic; or
(D) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-G-M-L-M)ₙ(-G-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic; or
(E) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-L-M-G-M)ₙ(-L-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic.

In yet another aspect, an air contactor membrane module comprising options (A) or (B) is described:
(A) a tubular housing for flowing liquid therethrough; and
a plurality of hollow fibers positioned within the tubular housing, wherein each hollow fiber comprises a membrane enclosing an interior for flowing gas therethrough, wherein the plurality of hollow fibers comprise pores for passage of a gaseous species from the interior through the membrane to the liquid, and wherein at least one side of the membrane of each hollow fiber is substantially hydrophobic; or
(B) a tubular housing for flowing gas therethrough; and
a plurality of hollow fibers positioned within the tubular housing, wherein each hollow fiber comprises a membrane enclosing an interior for flowing liquid therethrough, wherein the plurality of hollow fibers comprise pores for passage of a gaseous species through the membrane into the liquid in the interior, and wherein at least one side of the membrane of each hollow fiber is substantially hydrophobic,
wherein, the tubular housing further comprises (a) a housing inlet connector and a housing outlet connector, wherein the housing inlet connector is in liquid communication with a liquid source and the housing outlet connector is in liquid communication with an apparatus or a container; and (b) a first end of the plurality of hollow fibers is in gaseous communication with a hollow fiber inlet connector for introduction of a gas to the interior of the plurality of hollow fibers, wherein a second end of the plurality of hollow fibers is in gaseous communication with a hollow fiber outlet connector for egress of a gas from the plurality of hollow fibers.

In still another aspect, an air contactor membrane module is described comprising a housing comprising stacked gas-liquid sections therein, wherein a gas and a liquid are partitioned or separated by a membrane, wherein stacked gas-liquid sections are arranged as (L-M-G-M-)ₙ-L, wherein G is a gas section, M is a membrane, L is a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic, wherein the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing.

In still another aspect, an air contactor membrane module comprising one of (D) or (E) is described:
(D) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-G-M-L-M)ₙ(-G-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic; or
(E) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-L-M-G-M)ₙ(-L-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic,
wherein the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing.

In another aspect, a method of directly capturing carbon dioxide from an air source using an air contactor membrane module is described, said method comprising:
introducing a gas and a liquid to an air contactor membrane module, wherein the liquid comprises hydroxide ions, wherein the gas comprises carbon dioxide and the gas is flowing countercurrent to the liquid, and wherein carbon dioxide passes through the pores of the membranes to enter the liquid to produce carbonate ions,
wherein the air contactor membrane module comprises one of options (A), (B), (C), (D) or (E):
(A) a tubular housing for flowing liquid therethrough; and
a plurality of hollow fibers positioned within the tubular housing, wherein each hollow fiber comprises a membrane enclosing an interior for flowing gas therethrough, wherein the plurality of hollow fibers comprise pores for passage of a gaseous species from the interior through the membrane to the liquid, and wherein at least one side of the membrane of each hollow fiber is substantially hydrophobic; or
(B) a tubular housing for flowing gas therethrough; and
a plurality of hollow fibers positioned within the tubular housing, wherein each hollow fiber comprises a membrane enclosing an interior for flowing liquid therethrough, wherein the plurality of hollow fibers comprise pores for passage of a gaseous species through the membrane into the liquid in the interior, and wherein at least one side of the membrane of each hollow fiber is substantially hydrophobic; or
(C) a housing comprising stacked gas-liquid sections therein, wherein a gas and a liquid are partitioned or separated by a membrane, wherein stacked gas-liquid sections are arranged as (L-M-G-M-)ₙ-L or (G-M-L-M-)ₙ-G, wherein G is a gas section, M is a membrane, Lis a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic; or
(D) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-G-M-L-M)ₙ(-G-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic; or
(E) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-L-M-G-M)ₙ(-L-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic.

Other aspects, features and advantages of the invention will be more fully apparent from the ensuing disclosure and appended claims.

### BRIEF DESCRIPTION OF THE FIGURES

FIG. 1. Schematic diagram of the passage of CO₂ through pores of a membrane and reaction of the CO₂ in the hydroxide solution.

FIG. 2A. Schematic diagram of one embodiment of a membrane air contactor as described herein.

FIG. 2B. Schematic diagram of one embodiment of a membrane air contactor as described herein.

FIG. 2C. Schematic diagram of one embodiment of a membrane air contactor as described herein.

FIG. 3A. Capture efficiency and output solution pH as a function of different air flow rates.

FIG. 3B. Capture efficiency and output solution pH as a function of different liquid flow rates.

FIG. 3C. Capture efficiency and output solution pH as a function of different NaOH concentrations.

### DETAILED DESCRIPTION OF THE DISCLOSURE

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Sorrell, Organic Chemistry, 2^{nd} edition, University Science Books, Sausalito, 2006; Smith, March's Advanced Organic Chemistry: Reactions, Mechanism, and Structure, 7^{th} Edition, John Wiley & Sons, Inc., New York, 2013; Larock, Comprehensive Organic Transformations, 3^{rd} Edition, John Wiley & Sons, Inc., New York, 2018; and Carruthers, Some Modern Methods of Organic Synthesis, 3^{rd} Edition, Cambridge University Press, Cambridge, 1987; the entire contents of each of which are incorporated herein by reference.

“Substantially devoid” is defined herein to mean that none of the indicated substance is intentionally added or present. For example, less than about 1 wt %, preferably less than about 0.1 wt %, and even more preferably less than about 0.01 wt % of the indicated substance is present.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The expressions “ambient temperature” and “room temperature” as used herein are understood in the art and refer generally to a temperature from about 20° C. to about 35° C.

As used herein, a “membrane” is a sheet comprising two sides (or walls or faces). In some embodiments, the membrane is arranged substantially planar in an air contactor apparatus and there is a first side/face and a second side/face. In some embodiments, the membrane is arranged as a tube or cylinder such that there is a side or wall of the membrane on the interior of the tube or cylinder and there is side or wall of the membrane on the exterior of the tube or cylinder.

As used herein, “ingress” corresponds to the entry of a fluid (e.g., gas or liquid) into the recited object (e.g., membrane module or hollow fibers tubes). As used herein, “egress” corresponds to the exit of the fluid from the recited object.

As used herein, reference to a “carbonate solution” is intended to refer to a solution comprising bicarbonate ions, carbonate ions, or a combination thereof. As used herein, reference to “carbonate ions” is intended to refer to bicarbonate ions, carbonate ions, or a combination thereof.

Ranges of values for chemical concentrations, flow rates, operating temperatures and currents are disclosed herein. The ranges set out a lower limit value and upper limit value. Unless otherwise stated, the ranges include all values to the magnitude of the smallest value (either lower limit values or upper limit value) and ranges between the values of the stated range.

Direct air capture (DAC) of CO₂ has received increasing attention as a promising solution to the global challenges associated with the excessive emission of carbon. The present inventors introduced a direct air capture (DAC) system and method of using same in U.S. Provisional Patent Application No. 63/369,699, filed on Jul. 28, 2022, in the name of Chao Wang and Hao Shen and entitled “Energy Efficient Direct Air Capture of Carbon Dioxide Using Electrochemically Regenerated Sorbents,” U.S. Provisional Patent Application No. 63/375,088, filed on Sep. 9, 2022, in the name of Chao Wang et al. and entitled “Carbon-Negative Mining Enabled by Electrosynthesis of Acid and Alkaline,” International Patent Application No. PCT/US2023/071102, filed on Jul. 27, 2023, in the name of Chao Wang et al. and entitled “Electrolyzers,” and International Patent Application No. PCT/US2023/071105, filed on Jul. 27, 2023, in the name of Chao Wang et al. and entitled “Electrolyzers and Use of the Same for Carbon Dioxide Capture and Mining,” which are hereby incorporated by reference herein in their entirety. An embodiment of the DAC system described in the 63/369,699 application comprised one or more electro-synthesizers that can electrochemically produce an acid solution and a base solution, an air contactor that captures carbon dioxide from a gas source comprising carbon dioxide by reacting the carbon dioxide with a portion of the base solution to produce a carbonate solution, and a neutralizer that combines the carbonate solution with a portion of the acid solution to produce pure carbon dioxide gas and a solution comprising a brine salt. In practice, the method of using the DAC system to capture CO₂ from a gas source comprises applying a voltage across a gas-diffusion anode and a cathode in an electro-synthesizer unit, wherein water in a cathode electrolyte is electro-reduced into hydrogen gas and hydroxide ions at the cathode and wherein hydrogen produced at the cathode is flowed to an anode electrolyte and electro-oxidized at the gas-diffusion anode into hydrogen ions; directing a portion of the cathode electrolyte comprising the hydroxide ions to an air contactor, wherein a gas source comprising carbon dioxide is contacted with the hydroxide ions to produce a carbonate solution; and directing the carbonate solution and a portion of the anode electrolyte comprising hydrogen ions to a neutralizer, wherein the carbonate solution is contacted with anode electrolyte to produce a salt solution and carbon dioxide, wherein the salt solution is directed to the electro-synthesizer unit to replenish a brine solution therein.

At the core of the DAC system, the air contactor determines the CO₂ capture efficiency and the energy consumption of the whole system. In some embodiments, air contactors of the prior art can be used in the DAC system. In some embodiments, a membrane air contactor, as described herein, which can improve CO₂ capture efficiency and reduce system energy consumption, can be used in a DAC system.

Broadly, an air contactor membrane module is described herein, wherein said air contactor membrane module comprises a housing and a plurality of membranes within said housing. The plurality of membranes, comprised of modified polypropylene, create a barrier separating a gas phase from a liquid phase. The polypropylene material of the membranes comprises pores such that specific molecules in the gas phase can diffuse through the membrane and into the liquid phase to react with the liquid phase. At least one surface or side of the membranes is designed to be substantially hydrophobic, which effectively prevents water molecules from entering the gas phase.

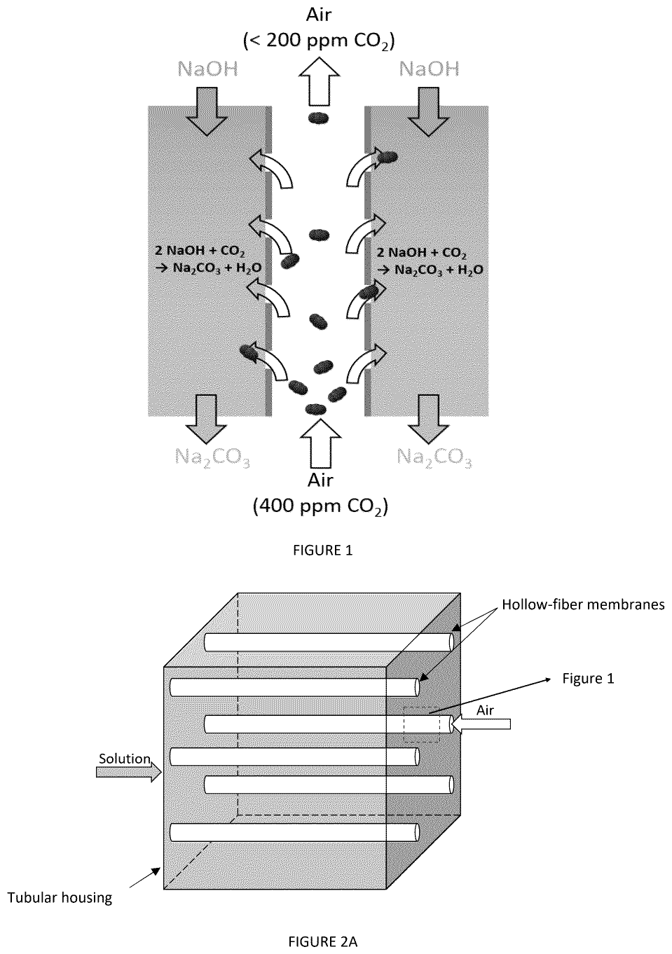

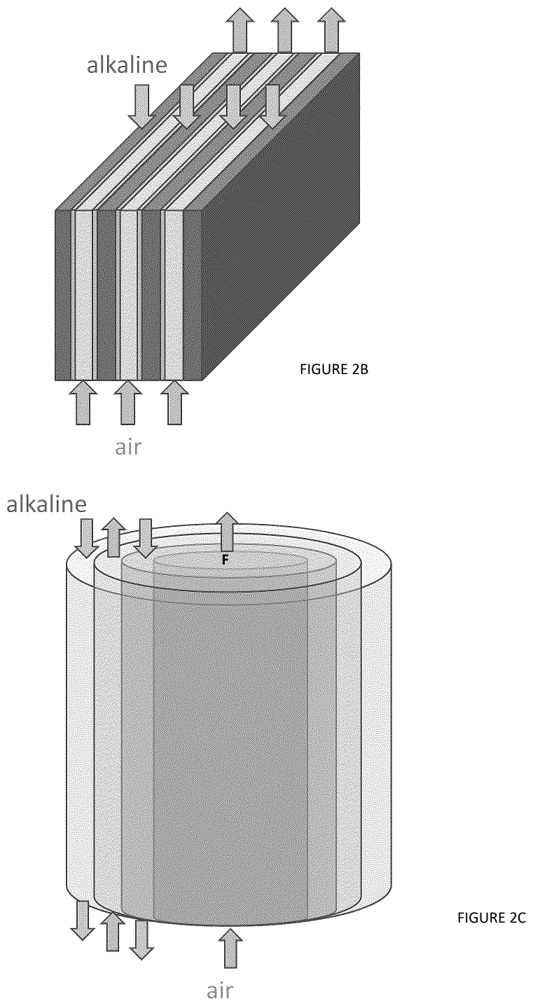

In a first aspect, the air contactor membrane module comprises a tubular housing and a plurality of hollow fiber membranes within said tubular housing, for example as shown in FIG. 2A. The gas phase flows inside of the plurality of hollow fibers, and the liquid phase flows inside the tubular housing and is in contact with the outside surface of the plurality of hollow fibers. The gas phase flows in a direction that is countercurrent, and parallel to, to the direction of the liquid phase (see, for example, FIG. 1). At least one side or wall of the membrane of each hollow fiber is substantially hydrophobic, which effectively prevents water molecules from entering the gas phase inside the plurality of hollow fibers. In some embodiments, the tubular housing generally is a cylinder which accommodates the plurality of hollow fiber membranes inside same. The tubular housing cylinder comprises a length and a header at each end of the column (not shown). In some embodiments, the two headers are separate and distinct from the tubular housing. In some embodiments, the two headers and the tubular housing comprise an inseparable one-piece member. In some embodiments, the tubular housing cylinder has a 2-dimensional cross-section selected from the group consisting of a square, rectangle, circle, polygon, and an ellipse. In some embodiments, the tubular housing is a cylinder having a circular or elliptical cross-section. In some embodiments, the cylinder has an approximate diameter of about 5 cm to about 30 cm, an approximate length in a range from about 0.5 m to about 2 m, and an approximate thickness of a wall of the cylinder is in a range from about 2 mm to about 10 mm. In some embodiments, the tubular housing comprises a polymer material that is non-corrosive when in contact with a hydroxide or carbonate solution including, but not limited to polyvinyl chloride (PVC) and polypropylene (PP). In some embodiments, each of the plurality of hollow fiber membranes has a cylindrical shape having a 2-dimensional cross-section that is substantially circular. In some embodiments, the plurality of hollow fiber membranes have an approximate diameter of about 0.01 mm to about 1 mm and an approximate length less than the length of the tubular housing. In some embodiments, the plurality of hollow fiber membranes are positioned within the housing so as to maximize the surface area of hollow fiber membrane in contact with the liquid source, as understood by the person skilled in the art.

Although not shown, in some embodiments of the first aspect, the air contactor membrane module comprises a tubular housing and a plurality of hollow fiber membranes within said tubular housing, wherein the liquid phase flows inside of the plurality of hollow fibers, and the gas phase flows inside the tubular housing and is in contact with the outside surface of the plurality of hollow fibers.

Accordingly, in a first aspect, an air contactor membrane module is described, said air contactor membrane module comprising either (A) or (B):
(A) a tubular housing for flowing liquid therethrough; and
a plurality of hollow fibers positioned within the tubular housing, wherein each hollow fiber comprises a membrane enclosing an interior for flowing gas therethrough, wherein the plurality of hollow fibers comprise pores for passage of a gaseous species from the interior through the membrane to the liquid, and wherein at least one side of the membrane of each hollow fiber is substantially hydrophobic; or
(B) a tubular housing for flowing gas therethrough; and
a plurality of hollow fibers positioned within the tubular housing, wherein each hollow fiber comprises a membrane enclosing an interior for flowing liquid therethrough, wherein the plurality of hollow fibers comprise pores for passage of a gaseous species through the membrane into the liquid in the interior, and wherein at least one side of the membrane of each hollow fiber is substantially hydrophobic.
   In some embodiments, the housing comprises a polymer material that is non-corrosive when in contact with a hydroxide or carbonate solution. In some embodiments, the membranes comprise modified polypropylene. In some embodiments, the gaseous species comprise carbon dioxide. In some embodiments, the liquid comprises a hydroxide solution. In some embodiments, the hydroxide solution is selected from the group consisting of lithium hydroxide, sodium hydroxide, potassium hydroxide, calcium hydroxide, and magnesium hydroxide. In some embodiments, the housing is cylindrical and comprises a header at each end. In some embodiments, the housing has a 2-dimensional cross-section selected from the group consisting of a square, rectangle, circle, polygon, and an ellipse. In some embodiments, each of the plurality of hollow fibers has a cylindrical or tubular shape having a 2-dimensional cross-section that is substantially circular. In some embodiments, the tubular housing further comprises (a) a housing inlet connector and a housing outlet connector, wherein the housing inlet connector is in liquid communication with a liquid source and the housing outlet connector is in liquid communication with an apparatus or a container; and (b) a first end of the plurality of hollow fibers is in gaseous communication with a hollow fiber inlet connector for introduction of a gas to the interior of the plurality of hollow fibers, wherein a second end of the plurality of hollow fibers is in gaseous communication with a hollow fiber outlet connector for egress of a gas from the plurality of hollow fibers. In some embodiments, a solution comprising carbonate flows from the housing to an apparatus (such as a neutralizer) or container.

In a second aspect, the air contactor membrane module comprises stacked gas-liquid sections, wherein the gas phase and liquid phase are partitioned by a membrane, for example as shown in FIG. 2B. Each gas phase section flows between two membranes, and some liquid phase sections flow between two membranes, wherein neighboring gas phase sections-liquid phase sections share the same membrane. The general arrangement is (L-M-G-M-)ₙ-L, wherein G is a gas phase section, M is a membrane, L is a liquid phase section, and n=1, 2, 3, 4, 5, 6, 7, 8, 9, 10, etc. The gas phase flows in a direction parallel and countercurrent (180°) or perpendicular) (90°) to the direction of the liquid phase. In some embodiments, at least one side of the membrane wall is substantially hydrophobic, which effectively prevents water molecules from entering the gas phase. In some embodiments, at least the side of the membrane wall that is in contact with the liquid phase is substantially hydrophobic. In some embodiments, the general arrangement is (L-(HM)-G-(MH)-)ₙ-L, wherein G is a gas phase section, M is a membrane wherein H represents the side of said membrane that is substantially hydrophobic, L is a liquid phase section, and n=1, 2, 3, 4, 5, 6, 7, 8, 9, 10, etc. In some embodiments, the air contactor membrane module further comprises a housing that holds the stacked gas-liquid sections, for example, a housing comprising a polymer material as described in the first aspect. Although not shown, it should be appreciated that in some embodiments, the arrangement of the second aspect can be (G-M-L-M-)ₙ-G or (G-(MH)-L-(HM)-)ₙ-G.

Accordingly, yet another air contactor membrane module is described, said air contactor membrane module comprising a housing comprising stacked gas-liquid sections therein, wherein a gas and a liquid are partitioned or separated by a membrane, wherein stacked gas-liquid sections are arranged as (L-M-G-M-)ₙ-L, wherein G is a gas section, M is a membrane, L is a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic. In some embodiments, the housing comprises a polymer material that is non-corrosive when in contact with a hydroxide or carbonate solution. In some embodiments, the membranes comprise modified polypropylene. In some embodiments, the gaseous species comprise carbon dioxide. In some embodiments, the liquid comprises a hydroxide solution. In some embodiments, the hydroxide solution is selected from the group consisting of lithium hydroxide, sodium hydroxide, potassium hydroxide, calcium hydroxide, and magnesium hydroxide. In some embodiments, the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing. In some embodiments, a solution comprising carbonate flows from the housing to an apparatus (such as a neutralizer) or container.

Accordingly, still another air contactor membrane module is described, said air contactor membrane module comprising a housing comprising stacked gas-liquid sections therein, wherein a gas and a liquid are partitioned or separated by a membrane, wherein stacked gas-liquid sections are arranged as (G-M-L-M-)ₙ-G, wherein G is a gas section, M is a membrane, L is a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic. In some embodiments, the housing comprises a polymer material that is non-corrosive when in contact with a hydroxide or carbonate solution. In some embodiments, the membranes comprise modified polypropylene. In some embodiments, the gaseous species comprise carbon dioxide. In some embodiments, the liquid comprises a hydroxide solution. In some embodiments, the hydroxide solution is selected from the group consisting of lithium hydroxide, sodium hydroxide, potassium hydroxide, calcium hydroxide, and magnesium hydroxide. In some embodiments, the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing. In some embodiments, a solution comprising carbonate flows from the housing to an apparatus (such as a neutralizer) or container.

In a third aspect, the air contactor membrane module comprises substantially concentric annulated gas-liquid sections, wherein the gas phase and liquid phase are partitioned by a membrane, for example as shown in FIG. 2C. The air contactor membrane module of this embodiment comprises a substantially central tubular membrane having a focus F point (center), for example, for flow of a gas phase within said tube. Additional annulations around the central tubular membrane switch from liquid phase to gas phase such that each subsequent gas phase section flows between two annulated membranes, and each liquid phase section flows between two annulated membranes, wherein neighboring gas phase sections-liquid phase sections share the same membrane. The general arrangement from the focus point F to the outermost annulation, along a radius line, is F(-G-M-L-M)ₙ(-G-M)ₘ, wherein G is a gas phase section, M is a membrane, L is a liquid phase section, m=0 or 1, and n=1, 2, 3, 4, 5, 6, 7, 8, 9, 10, etc. The gas phase flows in a direction parallel and countercurrent to the direction of the liquid phase. In some embodiments, at least one side of the membrane wall is substantially hydrophobic, which effectively prevents water molecules from entering the gas phase. In some embodiments, at least the side of the membrane wall that is in contact with the liquid phase is substantially hydrophobic. In some embodiments, the general arrangement from the focus point F to the outermost annulation, along a radius line, is F(-G-MH-L-HM)ₙ(-G-M)ₘ, wherein G is a gas phase section, M is a membrane wherein H represents the side of said membrane that is substantially hydrophobic, L is a liquid phase section, m=0 or 1, and n=1, 2, 3, 4, 5, 6, 7, 8, 9, 10, etc. In some embodiments, the outermost annulation of membrane is replaced by another material of construction, for example, a tubular housing comprising a polymer material as described in the first aspect.

Although not shown, in some embodiments of the third aspect, the air contactor membrane module comprises a substantially central tubular membrane having a focus F point (center), for example, for flow of a liquid phase within said tube. Additional annulations around the central tubular membrane switch from gas phase to liquid phase such that each gas phase section flows between two annulated membranes, and each subsequent liquid phase section flows between two annulated membranes, wherein neighboring gas phase sections-liquid phase sections share the same membrane. The general arrangement from the focus F point to the outermost annulation along a radius line is F(-L-M-G-M)ₙ(-L-M)ₘ, wherein G is a gas phase section, M is a membrane, L is a liquid phase section, m=0 or 1, and n=1, 2, 3, 4, 5, 6, 7, 8, 9, 10, etc. The gas phase flows in a direction parallel and countercurrent to the direction of the liquid phase. In some embodiments, at least one side of the membrane wall is substantially hydrophobic, which effectively prevents water molecules from entering the gas phase. In some embodiments, at least the side of the membrane wall that is in contact with the liquid phase is substantially hydrophobic. In some embodiments, the general arrangement from the focus F point to the outermost annulation along a radius line is F(-L-HM-G-MH)ₙ(-L-HM)ₘ, wherein G is a gas phase section, M is a membrane wherein represents the side of said membrane that is substantially hydrophobic, L is a liquid phase section, m=0 or 1, and n=1, 2, 3, 4, 5, 6, 7, 8, 9, 10, etc. In some embodiments, the outermost annulation of membrane is replaced by another material of construction, for example, a tubular housing comprising a polymer material as described in the first aspect.

Accordingly, another air contactor membrane module is described, said air contactor membrane module comprising one of (D) or (E):
(D) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-G-M-L-M)ₙ(-G-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic; or
(E) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-L-M-G-M)ₙ(-L-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic.
   In some embodiments, the housing comprises a polymer material that is non-corrosive when in contact with a hydroxide or carbonate solution. In some embodiments, the membranes comprise modified polypropylene. In some embodiments, the gaseous species comprise carbon dioxide. In some embodiments, the liquid comprises a hydroxide solution. In some embodiments, the hydroxide solution is selected from the group consisting of lithium hydroxide, sodium hydroxide, potassium hydroxide, calcium hydroxide, and magnesium hydroxide. In some embodiments, the housing is cylindrical and comprises a header at each end. In some embodiments, the housing has a 2-dimensional cross-section selected from the group consisting of a square, rectangle, circle, polygon, and an ellipse. In some embodiments, the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing. In some embodiments, a solution comprising carbonate flows from the housing to an apparatus (such as a neutralizer) or container.

In some embodiments, the membranes comprise polypropylene. In some embodiments, the membranes comprise a modified polypropylene. In some embodiments, the substantially hydrophobic material comprises material selected from the group consisting of polyethylene (PE), polypropylene (PP), polystyrene (PS), PVC, polytetrafluoroethylene (PTFE), and any combination thereof. In some embodiments, the polypropylene material of the membranes comprises pores such that carbon dioxide gas can diffuse through the membrane and into the liquid source to react with the components of the liquid. In some embodiments, the size of the pores is in a range from about 0.01 μm to about 0.2 μm. In some embodiments, the size of the pores is in a range from about 0.01 μm to about 0.1 μm. In some embodiments, the membranes are hydrophobic throughout. In some embodiments, only one side or face or wall of the membrane is hydrophobic. In some embodiments, both sides or faces or walls of the membrane are hydrophobic.

In some embodiments, the gas phase comprises carbon dioxide and the CO₂ diffuses from the gas phase into the liquid source through the pores of the membranes. In some embodiments, the liquid source comprises a hydroxide solution. In some embodiments, the liquid source comprises a hydroxide solution selected from the group consisting of lithium hydroxide, sodium hydroxide, potassium hydroxide, calcium hydroxide, and magnesium hydroxide. In some embodiments, the gas phase comprises CO₂ and the liquid source comprises a hydroxide solution and upon reaction, a carbonate solution is produced in the liquid source. In some embodiments, the gas phase comprises CO₂ and the liquid source comprises sodium hydroxide solution and upon reaction, a solution comprising sodium carbonate is produced. In some embodiments, the gas phase comprises CO₂ and the liquid source comprises lithium hydroxide solution and upon reaction, a solution comprising lithium carbonate is produced. In some embodiments, the gas phase comprises CO₂ and the liquid source comprises potassium hydroxide solution and upon reaction, a solution comprising potassium carbonate is produced. In some embodiments, the concentration of hydroxide solution is at least 0.1 mol/L In some embodiments, the concentration of hydroxide solution is at least 1 mol/L.

In some embodiments, the air contactor membrane module further comprises means for connecting a first end of the membrane module to a gas source for introduction of a first gas phase at an inlet and for connecting a second end of the membrane module to an outlet for egress of a second gas phase therefrom, wherein the amount of carbon dioxide in the first gas phase is greater than the amount of carbon dioxide in the second gas phase, and wherein a liquid from the liquid source cannot pass through the membranes into the gas phase. For example, in some embodiments, the gas source inlet comprises an inlet manifold, wherein the first end of the membrane module can be communicatively connected to the inlet manifold, and wherein the inlet manifold is in communication with the inlet. In some embodiments, the gas source outlet comprises an outlet manifold, wherein the second end of the membrane module can be communicatively connected to the outlet manifold, and wherein the outlet manifold is in communication with the outlet. In some embodiments, the air contactor membrane module further comprises means for connecting the second end of the membrane module to a liquid source feed for introduction of a hydroxide solution at an inlet and for connecting the first end of the membrane module to an outlet for egress of a carbonate solution therefrom (see for example FIG. 1). It should be appreciated by the person skilled in the art that a liquid source entering any of the air contactor membrane modules described herein will have a higher concentration of hydroxide ions than the liquid source exiting the air contactor membrane module, assuming there is CO₂ available for the reaction. Analogously, a liquid source entering any of the air contactor membrane modules described herein will have a lower concentration of carbonate ions than the liquid source exiting said same air contactor membrane module, assuming there is CO₂ and hydroxide available for the reaction. In some embodiments, the inlet and/or outlet for the gas phase is positioned along the length of the tubular housing. In some embodiments, the inlet and/or outlet for the liquid source is positioned along the length of the tubular housing. In some embodiments, the inlet and/or outlet for the gas phase is positioned on the headers which engage with the tubular housing. In some embodiments, the inlet and/or outlet for the liquid source is positioned on the headers which engage with the tubular housing. The construction of membrane modules is known in the art.

In some embodiments, the flow of the liquid source, e.g., hydroxide solution, through the air contactor membrane module is controlled to be about 50 mL/hr to about 200 mL/hr. In some embodiments, the flow of the liquid source through the air contactor membrane module is controlled to be about 75 mL/hr to about 125 mL/hr. In some embodiments, the flow of gas phase through the air contactor membrane module is in a range from about 5 L/min to about 50 L/min. In some embodiments, the flow of gas phase through the air contactor membrane module is in a range from about 15 L/min to about 40 L/min. In some embodiments, the flow of gas phase through the air contactor membrane module is in a range from about 15 L/min to about 25 L/min. In some embodiments, the concentration of hydroxide in the liquid is in a range from about 0.05 M to about 6 M. In some embodiments, the concentration of hydroxide in the liquid is in a range from about 0.05 M to about 5 M. In some embodiments, the concentration of hydroxide in the liquid is in a range from about 0.05 M to about 4 M. In some embodiments, the concentration of hydroxide in the liquid is in a range from about 0.05 M to about 3 M. In some embodiments, the concentration of hydroxide in the liquid is in a range from about 0.05 M to about 2 M. In some embodiments, the concentration of hydroxide in the liquid is in a range from about 0.05 M to about 1 M. In some embodiments, the concentration of hydroxide in the liquid is in a range from about 0.4 M to about 2 M. In some embodiments, the concentration of hydroxide in the liquid is in a range from about 0.4 M to about 1 M. In some embodiments, the concentration of hydroxide in the liquid is in a range from about 1 M to about 2 M. Advantageously, unlike the air contactors of the prior art, the method of using the air contactor membrane module described herein does not require high temperatures (e.g., greater than 100° C.) to regenerate a sorbent nor a large pressure difference (e.g., in a fluidized bed reactor). In some embodiments, the reactions associated with the air contactor membrane module described herein can take place under ambient conditions, e.g., ambient temperatures and/or ambient pressures.

The captured carbon dioxide reacts with the base solution, e.g., comprising hydroxide ions, to form a carbonate solution. In some embodiments, the one or more air contactor membrane module captures CO₂ and generates a gas (e.g., at the egress) that comprises less than about 200 ppm of carbon dioxide, less than about 100 ppm of carbon dioxide, less than about 50 ppm of carbon dioxide, or less than about 10 ppm of carbon dioxide. In yet still further aspects, the generated gas is substantially free of carbon dioxide.

Advantageously, because the membranes in the air contactor membrane module are completely surrounded by a solution comprising hydroxide ions, there is a large gas-liquid contact area which greatly improves the CO₂ capture efficiency. This design also allows for extremely slow fluid flow therethrough which significantly reduces the energy consumption of the whole air contactor system. In addition, because of the hydrophobicity of at least one side of the membrane, e.g., comprising polypropylene, water molecules cannot pass through the membranes into the gas phase. This effectively avoids the solvent loss caused by direct gas-liquid contact of traditional packed air contactors.

In a fourth aspect, a method of directly capturing carbon dioxide from an air source using any air contactor membrane module of the first, second or third aspects is described, said method comprising:
introducing a gas and a liquid to the air contactor membrane module, wherein the liquid comprises hydroxide ions, wherein the gas comprises carbon dioxide and the gas is flowing countercurrent to the liquid, and wherein carbon dioxide passes through the pores of the membranes to enter the liquid to produce carbonate ions.
   In some embodiments, a concentration of carbon dioxide at ingress of the gas to the air contactor membrane module is greater than the concentration of carbon dioxide at the egress of the gas from the air contactor membrane module. In some embodiments, a concentration of hydroxide at ingress of the liquid to the air contactor membrane module is greater than the concentration of hydroxide at the egress of the liquid from the air contactor membrane module. In some embodiments, a concentration of carbonate at ingress of the liquid to the air contactor membrane module is less than the concentration of carbonate at the egress of the liquid from the air contactor membrane module.

In some embodiments, the system and method described herein relates to the extraction, reduction, capture, disposal, sequestration or storage of CO₂, for example from air, but also from other emission sources. In some embodiments, the gas phase comprises air. In some embodiments, the gas phase comprises gas from various industrial sources that release carbon dioxide including carbon dioxide from combustion gases of fossil fueled power plants, e.g., conventional coal, oil and gas power plants, or IGCC (Integrated Gasification Combined Cycle) power plants that generate power by burning syngas; cement manufacturing plants that convert limestone to lime; ore processing plants; fermentation plants; and the like. In some embodiments, the gas phase may comprise other gases, e.g., nitrogen, oxides of nitrogen (nitrous oxide, nitric oxide), sulfur and sulfur gases (sulfur dioxide, hydrogen sulfide), and vaporized materials. In some embodiments, the system includes a gas treatment system that removes at least a portion of the other gases in the gas phase before the gas phase comprising CO₂ is introduced to the air contactor membrane module.

In some embodiments, the air contactor membrane module is associated with a heat exchanger. In some embodiments, the heat exchanger comprises a recirculation-based system. Because the air contactor unit is endothermic, a heat exchanger can extract heat from another apparatus and provide energy to the air contactor, thereby reducing overall energy usage.

In some embodiments, at least one electro-synthesizer system, which generates a hydroxide solution therein, provides the hydroxide sorbent to the air contactor membrane module. In some embodiments, the carbonate solution produced in the air contactor membrane module is provided to an apparatus such as a neutralizer to neutralize acids therein or temporarily to a container. In some embodiments, the air contactor membrane module is capturing CO₂ continuously, even when the electro-synthesizer system and/or the neutralizer are stopped or offline. For example, in some aspects, the flow electro-synthesizer units can utilize off-peak periods when the energy is cheap. In such exemplary and unlimiting aspects, the flow electro-synthesizer units can be stopped when energy is expensive and operate only when energy is cheap. In certain aspects, the generated acids/bases can be utilized immediately. While in other aspects, the generated acids/bases can be collected for further desired applications. In yet still further aspects, other parts of the system, for example, the carbon capturing apparatus and/or the one or more neutralizers, operate continuously without interruptions.

### EXAMPLE

Systematic studies of the membrane air contactor were performed. Air flow rate, liquid flow rate and KOH concentration were three important parameters affecting capture efficiency.

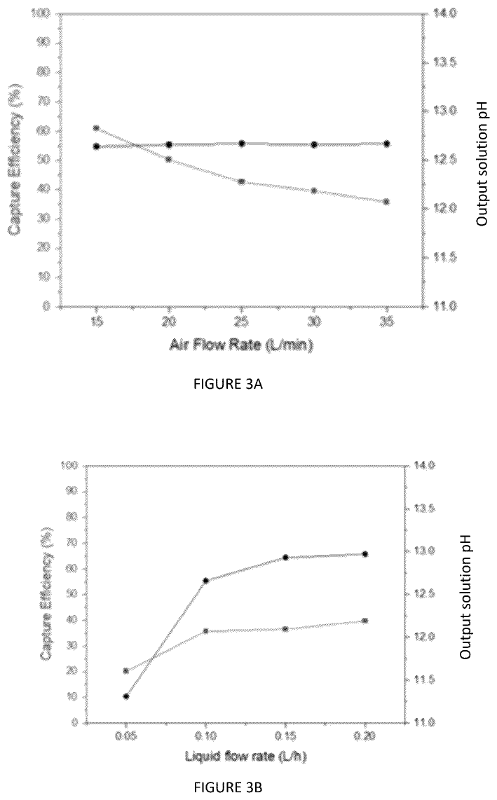

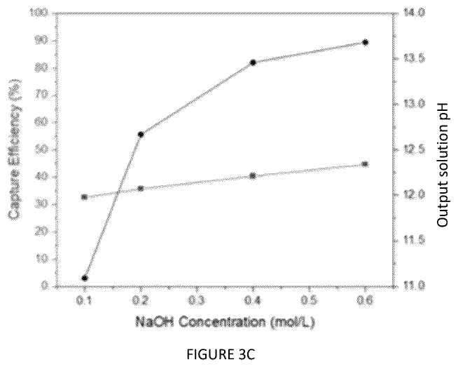

The preliminary experimental conditions were 35 L/min of air and 100 mL/h of 0.2 M NaOH. It has a maximum gas-liquid flow ratio of 21,000:1, greatly reducing the energy required to pump the liquid. In systematic studies, two parameters were fixed and the other one is changed to obtain a series of results. Among those three parameters, air flow rate shows the greatest influence on capture efficiency (FIG. 3A), wherein the capture efficiency of air contactor is limited by gas-liquid contact time. 50% capture efficiency is achieved at 20 L/min of air (FIG. 3A) and 100 mL/h of 0.2 M KOH (FIGS. 3B and 3C). Based on these preliminary data, this air contactor can achieve a CO₂ production rate of 10-20 g/day, with the rate mainly limited by the size.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. An air contactor membrane module comprising one of options (A), (B), (C), (D) or (E):
(A) a tubular housing for flowing liquid therethrough; and
a plurality of hollow fibers positioned within the tubular housing, wherein each hollow fiber comprises a membrane enclosing an interior for flowing gas therethrough, wherein the plurality of hollow fibers comprise pores for passage of a gaseous species from the interior through the membrane to the liquid, and wherein at least one side of the membrane of each hollow fiber is substantially hydrophobic; or
(B) a tubular housing for flowing gas therethrough; and
a plurality of hollow fibers positioned within the tubular housing, wherein each hollow fiber comprises a membrane enclosing an interior for flowing liquid therethrough, wherein the plurality of hollow fibers comprise pores for passage of a gaseous species through the membrane into the liquid in the interior, and wherein at least one side of the membrane of each hollow fiber is substantially hydrophobic; or
(C) a housing comprising stacked gas-liquid sections therein, wherein a gas and a liquid are partitioned or separated by a membrane, wherein stacked gas-liquid sections are arranged as (L-M-G-M-)ₙ-L or (G-M-L-M-)ₙ-G, wherein G is a gas section, M is a membrane, L is a liquid section, and n=1, 2, 3, 4, 5, 6, 7, 8, 9, or 10, wherein the membranes comprise pores for passage of a gaseous species from the gas to the liquid, and wherein at least one side of the membranes is substantially hydrophobic; or
(D) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-G-M-L-M)ₙ(-G-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic; or
(E) a housing comprising substantially concentric annulated gas-liquid sections, wherein a gas and a liquid are partitioned or separated by a membrane, wherein the substantially concentric annulated gas-liquid sections are arranged from a focal point F to an outermost annulation along a radius line as F(-L-M-G-M)ₙ(-L-M)ₘ, wherein G is a gas section, M is a membrane, L is a liquid section, m=0 or 1, and n=1, 2, 3, 4, 5, 6, 7, 8, 9, or 10, wherein the membranes comprise pores for passage of a gaseous species from the gas to the liquid, and wherein at least one surface of the membranes is substantially hydrophobic.

2. The air contactor membrane module of claim 1, wherein the housing comprises a polymer material that is non-corrosive when in contact with a hydroxide or carbonate solution.

3. The air contactor membrane module of claim 1, wherein the membranes comprise modified polypropylene.

4. The air contactor membrane module of claim 1, wherein the gaseous species comprise carbon dioxide.

5. The air contactor membrane module of claim 1, wherein the liquid comprises a hydroxide solution.

6. The air contactor membrane module of claim 5, wherein the hydroxide solution is selected from the group consisting of lithium hydroxide, sodium hydroxide, potassium hydroxide, calcium hydroxide, and magnesium hydroxide.

7. The air contactor membrane module of claim 1, comprising any of options (A), (B), (D), or (E), wherein the housing is cylindrical and comprises a header at each end.

8. The air contactor membrane module of claim 1, comprising any of options (A), (B), (D), or (E), wherein the housing has a 2-dimensional cross-section selected from the group consisting of a square, rectangle, circle, polygon, and an ellipse.

9. The air contactor membrane module of claim 1, comprising options (A) or (B), wherein each of the plurality of hollow fibers has a cylindrical or tubular shape having a 2-dimensional cross-section that is substantially circular.

10. The air contactor membrane module of claim 1, comprising options (A) or (B), wherein the tubular housing further comprises (a) a housing inlet connector and a housing outlet connector, wherein the housing inlet connector is in liquid communication with a liquid source and the housing outlet connector is in liquid communication with an apparatus or a container; and
(b) a first end of the plurality of hollow fibers is in gaseous communication with a hollow fiber inlet connector for introduction of a gas to the interior of the plurality of hollow fibers, wherein a second end of the plurality of hollow fibers is in gaseous communication with a hollow fiber outlet connector for egress of a gas from the plurality of hollow fibers.

11. The air contactor membrane module of claim 1, comprising (C), wherein the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing.

12. The air contactor membrane module of claim 1, comprising options (D) or (E), wherein the housing further comprises (a) a liquid inlet connector and a liquid outlet connector both in liquid communication with the liquid section, wherein the liquid inlet connector is in liquid communication with a liquid source and the liquid outlet connector is in liquid communication with an apparatus or container, and (b) a gas inlet connector and a gas outlet connector both in gaseous communication with the gas section, wherein the gas inlet connector is in gaseous communication with a gas source and the gas outlet connector is used for egress of a gas from the housing.

13. The air contactor membrane module of claim 10, wherein a solution comprising carbonate flows from the housing to an apparatus or container.

14. The air contactor membrane module of claim 13, wherein the apparatus is a neutralizer.

15. A method of directly capturing carbon dioxide from an air source using an air contactor membrane module of claim 1, said method comprising: introducing a gas and a liquid to the air contactor membrane module, wherein the liquid comprises hydroxide ions, wherein the gas comprises carbon dioxide and the gas is flowing countercurrent to the liquid, and wherein carbon dioxide passes through the pores of the membranes to enter the liquid to produce carbonate ions.

16. The method of claim 15, wherein a concentration of carbon dioxide at ingress of the gas to the air contactor membrane module is greater than the concentration of carbon dioxide at the egress of the gas from the air contactor membrane module.

17. The method of claim 15, wherein a concentration of hydroxide at ingress of the liquid to the air contactor membrane module is greater than the concentration of hydroxide at the egress of the liquid from the air contactor membrane module.

18. The method of claim 15, wherein a concentration of carbonate at ingress of the liquid to the air contactor membrane module is less than the concentration of carbonate at the egress of the liquid from the air contactor membrane module.
